(19) United States
(12) Patent Application Publication
(10) Pub. No.: US 2018/0158592 A1
(43) Pub. Date: Jun. 7, 2018

(54) COIL-INCLUDING COMPONENT

(71) Applicant: Murata Manufacturing Co., Ltd., Nagaokakyo-shi (JP)

(72) Inventor: Hirokazu YAZAKI, Nagaokakyo-shi (JP)

(21) Appl. No.: 15/888,123

(22) Filed: Feb. 5, 2018

Related U.S. Application Data
(63) Continuation of application No. PCT/JP2016/074233, filed on Aug. 19, 2016.

(30) Foreign Application Priority Data
Sep. 1, 2015 (JP) 2015-172346

(51) Int. Cl. H01F 27/28; H01F 27/245; H01F 27/29

(52) U.S. Cl. CPC H01F 27/2804; H01F 2027/2809; H01F 27/29; H01F 27/245

(57) ABSTRACT

A coil-including component includes first and second coil elements in a laminate element body. The first coil element includes first and second coil portions. The first coil portion includes coil patterns. The second coil portion includes a coil pattern. The second coil element includes a third coil portion that includes coil patterns. The third coil portion is provided between the first coil portion and the second coil portion. Magnetic layers are provided between the coil patterns of the first coil portion and between the coil patterns of the third coil portion. Intermediate layers having lower magnetic permeability than the magnetic permeability of the magnetic layers are provided between the first coil portion and the third coil portion and between the second coil portion and the third coil portion.

### CROSS REFERENCE TO RELATED APPLICATIONS

This application claims the benefit of priority to Japanese Patent Application No. 2015-172346 filed on Sep. 1, 2015 and is a Continuation Application of PCT Application No. PCT/JP2016/074233 filed on Aug. 19, 2016. The entire contents of each application are hereby incorporated herein by reference.

### BACKGROUND OF THE INVENTION

### 1. Field of the Invention

The present invention relates to coil-including components, and in particular, to laminated coil-including components including two coil elements therein.

### 2. Description of the Related Art

Coil-including components according to the related art in which two coil elements are provided in a multilayer substrate are known (for example, see Japanese Unexamined Patent Application Publication No. 2015-73052).

As illustrated in FIG. 1, a coil-including component described in Japanese Unexamined Patent Application Publication No. 2015-73052 includes a laminate element body 105 formed by laminating a plurality of magnetic layers. The coil-including component also includes a first coil element 110 and a second coil element 120 provided in the laminate element body 105. The first coil element 110 and the second coil element 120 are separately disposed on the upper side and the lower side in the laminating direction and coupled to each other through a magnetic field. A non-magnetic portion 140 is provided between coil patterns of the first coil element 110 and coil patterns of the second coil element 120 adjacent to each other in the laminating direction.

However, in a coil-including component 101 described in Japanese Unexamined Patent Application Publication No. 2015-73052, as illustrated in FIG. 1, a major loop m1 that is a magnetic flux along a winding axis of the first coil element 110 and the second coil element 120 and that links both of the coil elements 110 and 120 is provided. Other than the major loop m1, a minor loop m2 circling around a line of a coil pattern p is also provided. This minor loop m2 does not contribute to the coupling between the first coil element 110 and the second coil element 120 through the magnetic field. Thus, with the coil-including component in which the minor loop m2 is easily provided, there is a limit to the amount of improvement of the degree of coupling. That is, as is the case with the coil-including component 101, with a structure in which the first coil element 110 and the second coil element 120 are separately disposed in the up-down direction, it is difficult to increase the degree of coupling between the two coil elements.

### SUMMARY OF THE INVENTION

Preferred embodiments of the present invention provide coil-including components with which a degree of coupling between two coil elements is improved.

A coil-including component according to a preferred embodiment of the present invention includes a laminate element body, a first coil element, and a second coil element. The laminate element body includes a plurality of base material layers that are laminated. The first coil element and a second coil element are provided in the laminate element body such that coil surfaces of the first coil element and a coil surface of the second coil element face one another in a laminating direction. The first coil element includes at least a first coil portion and a second coil portion. The first coil portion includes at least two coil patterns adjacent to each other in the laminating direction. The second coil portion includes at least one coil pattern. The second coil element includes at least a third coil portion. The third coil portion includes at least two coil patterns adjacent to each other in the laminating direction. The third coil portion is provided between the first coil portion and the second coil portion. A magnetic layer is provided in at least one of positions between the at least two coil patterns included in the first coil portion and between the at least two coil patterns included in the third coil portion. An intermediate layer having a lower magnetic permeability than a magnetic permeability of the magnetic layer is provided in at least one of positions between the first coil portion and the third coil portion and between the second coil portion and the third coil portion.

As described above, the third coil portion of the second coil element is provided between the first coil portion and the second coil portion of the first coil element, and the intermediate layer having low magnetic permeability is provided in at least one of the positions between the first coil portion and the third coil portion and between the second coil portion and the third coil portion. With this structure, the formation of minor loops at the coil patterns is effectively reduced or prevented. As a result, the degree of coupling between the first coil element and the second coil element is improved. Furthermore, since the degree of coupling between the first coil element and the second coil element is improved, the degree of coupling is able to be adjusted in a large range by changing the positions and the numbers of the intermediate layers in the laminate element body.

Furthermore, the second coil portion may be provided in a lowermost layer or an uppermost layer in the laminating direction of the first coil element and the second coil element, and the at least one coil pattern of the second coil portion may include a single coil pattern.

Thus, the number of uppermost or lowermost coil patterns that are separated from the intermediate layer is able to be reduced so as to further reduce or prevent the formation of minor loops at the coil patterns. Accordingly, even when the coil-including component includes a small number of the coil patterns and has a reduced height (reduced size), the degree of coupling between the first coil element and the second coil element is improved.

Furthermore, the second coil element may include at least the third coil portion and a fourth coil portion that includes at least one coil pattern. The first coil portion may be provided between the third coil portion and the fourth coil portion. An intermediate layer having lower magnetic permeability than the magnetic permeability of the magnetic layer may be provided between the first coil portion and the fourth coil portion.

As described above, when the first coil portion is provided between the third coil portion and the fourth coil portion and the intermediate layer having low magnetic permeability is further provided between the first coil portion and the fourth coil portion, the number of coil patterns that are separated from the intermediate layer is able to be reduced. Thus, the formation of minor loops at the coil patterns is reduced or prevented, and the degree of coupling between the first coil element and the second coil element is further improved.

Furthermore, the fourth coil portion may be provided in a lowermost layer or an uppermost layer in the laminating direction of the first coil element and the second coil element, and the at least one coil pattern of the fourth coil portion may include a single coil pattern.

Thus, the number of uppermost or lowermost coil patterns that are separated from the intermediate layer is able to be reduced so as to further reduce or prevent the formation of minor loops at the coil patterns. Accordingly, even when the coil-including component includes a small number of the coil patterns and has a reduced height, the degree of coupling between the first coil element and the second coil element is improved.

Furthermore, the at least two coil patterns of the first coil portion may include two coil patterns and the at least two coil patterns of the third coil portion may include two coil patterns.

This configuration is able to reduce or prevent formation of minor loops at the first coil portion and the third coil portion. Accordingly, even when the coil-including component includes a small number of the coil patterns and has a reduced height, the degree of coupling between the first coil element and the second coil element is improved.

Furthermore, the intermediate layers may be provided between the coil patterns included in the first coil element and the coil patterns included in the second coil element adjacent to the corresponding coil patterns included in the first coil element in the laminating direction.

Thus, the formation of minor loops at the coil patterns is able to be reduced or prevented, and the degree of coupling between the first coil element and the second coil element is further improved.

Furthermore, the intermediate layers may be provided in entire regions parallel or substantially parallel to the coil surfaces of the laminate element body between the coil patterns included in the first coil element and the coil patterns included in the second coil element adjacent to the corresponding coil patterns included in the first coil element in the laminating direction.

Thus, the intermediate layers having low magnetic permeability are easily provided in the laminate element body.

Furthermore, the intermediate layers may be provided only in regions in which the coil patterns included in the first coil element and the coil patterns included in the second coil element adjacent to the corresponding coil patterns included in the first coil element in the laminating direction face one another.

With this structure, the formation of minor loops at the coil patterns is able to be reduced or prevented, and the intermediate layers do not obstruct a magnetic flux (major loop) produced along the windings of the first coil element and the second coil element. Thus, the degree of coupling between the first coil element and the second coil element is further improved.

Furthermore, the coil-including component may include a plurality of intermediate layers, and at least one of the plurality of intermediate layers may have a different thickness from a thickness of another intermediate layer or other intermediate layers.

With this structure, the magnetic permeability of the intermediate layers is able to be varied, and accordingly, the coil-including component in which the degree of coupling between the first coil element and the second coil element is highly accurately adjusted is provided.

According to preferred embodiments of the present invention, the degree of coupling between the two coil elements included in coil-including components is increased.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic sectional view of a related-art coil-including component.

FIG. 2 is a schematic sectional view of a coil-including component according to a first preferred embodiment of the present invention.

FIG. 3 is an equivalent circuit of the coil-including component according to the first preferred embodiment of the present invention.

FIG. 4 is a schematic sectional view of a coil-including component according to a first variant of the first preferred embodiment of the present invention.

FIG. 5 is a schematic sectional view of a coil-including component according to a second variant of the first preferred embodiment of the present invention.

FIG. 6 is a schematic sectional view of a coil-including component according to a third variant of the first preferred embodiment of the present invention.

FIG. 7 is a schematic sectional view of a coil-including component according to a fourth variant of the first preferred embodiment of the present invention.

FIG. 8 is a schematic sectional view of a coil-including component according to a second preferred embodiment of the present invention.

FIG. 9 illustrates base material layers included in the coil-including component illustrated in FIG. 8 and coil patterns provided in the base material layers and includes views (a) to (k) illustrating the base material layers and the coil patterns seen from a lower surface side.

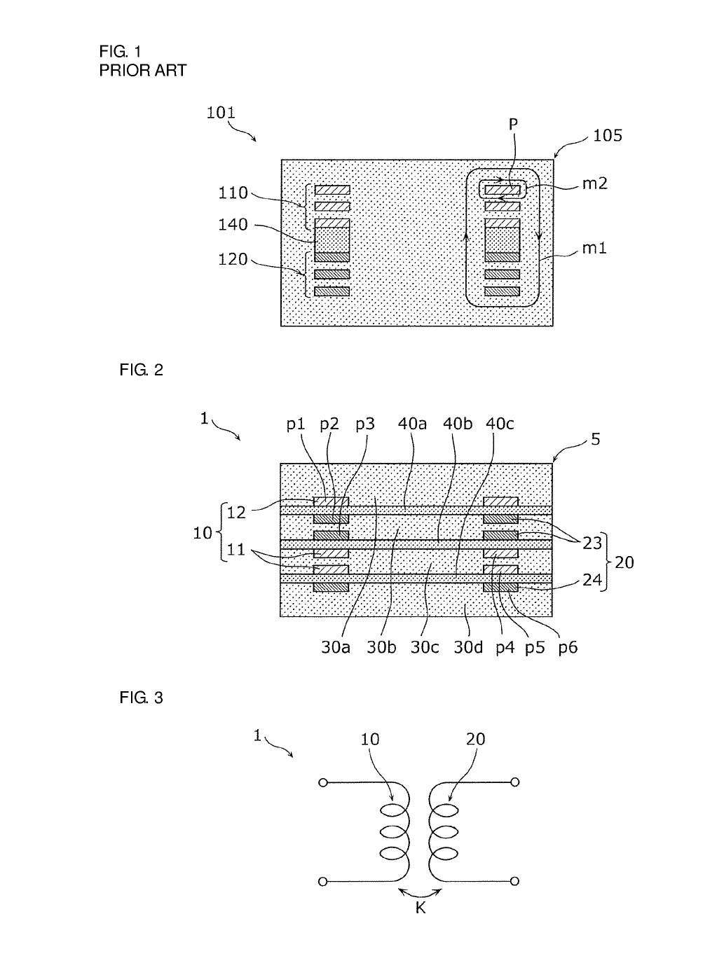

### DETAILED DESCRIPTION OF THE PREFERRED EMBODIMENTS

Preferred embodiments of the present invention will be described in detail below with reference to the drawings. The preferred embodiments described below represent comprehensive or specific examples. Values, shapes, materials, elements, arrangements, and connecting configurations of the elements, manufacturing steps, the order of the manufacturing steps, and so forth described in the preferred embodiments are examples and not intended to limit the present invention. Out of the elements to be described in the preferred embodiments, elements not described in the independent claim are described as arbitrary elements. Furthermore, the sizes of the elements or the ratios of the sizes of the elements illustrated in the drawings are not necessarily exact.

### First Preferred Embodiment

A coil-including component according to a first preferred embodiment of the present invention is a laminated coil-including component that includes two coil elements therein. Examples of this coil-including component are not limited to dual inductors, such as a common mode choke coil, a transformer, a coupler, and a balun, for example. The coil-including component may also be a component included in a multilayer circuit component, such as a choke coil for a multiphase DC-DC converter, for example. According to the present preferred embodiment, a dual inductor exemplifies the coil-including component.

FIG. 2 is a schematic sectional view of a coil-including component 1 according to the present preferred embodiment. FIG. 3 illustrates an equivalent circuit of the coil-including component 1 according to the present preferred embodiment. Hereafter, for conciseness, elements of the same or similar type are indicated by the same or similar patterns so as to appropriately omit reference signs, and elements disposed in different sections when exactly illustrated may be in the same drawing.

As illustrated in FIG. 2, the coil-including component 1 includes a laminate element body 5 including a plurality of base material layers that are laminated. The coil-including component 1 also includes a first coil element 10 and a second coil element 20 provided in the laminate element body 5 such that coil surfaces of the first coil element 10 and the second coil element 20 face one another in a laminating direction.

The plurality of base material layers include magnetic layers 30 (30a, 30b, 30c, and 30d) and intermediate layers 40 (40a, 40b, and 40c). The magnetic layers 30 are preferably made of a magnetic material. The magnetic permeability of the intermediate layers 40 is preferably lower than that of the magnetic layers 30. Specifically, the intermediate layers 40 are made of a material having a lower magnetic permeability than that of the material of the magnetic layers 30.

Winding axes (coil axes) of the first coil element 10 and the second coil element 20 are coincident or substantially coincident with each other, and the first coil element 10 and the second coil element 20 are coupled to each other through a magnetic field (see FIG. 3). These coil elements 10 and 20 are each defined by some of a plurality of coil patterns p (p1, p2, p3, p4, p5, and p6) that are in-plane conductors. The coil patterns p according to the present preferred embodiment each preferably include a coil pattern of less than one turn, for example.

The first coil element 10 includes a first coil portion 11 and a second coil portion 12. The first coil portion 11 includes two coil patterns p4 and p5 adjacent to each other in the laminating direction. The second coil portion 12 includes another coil pattern p1 that faces coil surfaces of the first coil portion 11. Here, the term “coil portion” refers to a partial structure of the coil element. For example, the coil portions included in the first coil element 10 are not limited to the first coil portion 11 and the second coil portion 12. A coil portion other than the first coil portion 11 and the second coil portion 12 may be further included in the first coil element 10.

The second coil element 20 includes a third coil portion 23 and a fourth coil portion 24. The third coil portion 23 includes two coil patterns p2 and p3 adjacent to each other in the laminating direction. The fourth coil portion 24 includes another coil pattern p6 that faces coil surfaces of the third coil portion 23.

The third coil portion 23 of the second coil element 20 is provided between the first coil portion 11 and the second coil portion 12. The first coil portion 11 of the first coil element 10 is provided between the third coil portion 23 and the fourth coil portion 24. That is, some of the coil patterns p1, p4, and p5 of the first coil element 10 and some of the coil patterns p2, p3, and p6 of the second coil element 20 are arranged in an alternating sequence in the laminating direction.

Furthermore, the second coil portion 12 of the first coil element 10 is preferably a single coil pattern p1 and provided in an uppermost layer of the first coil element 10 and the second coil element 20 in the laminating direction. The fourth coil portion 24 of the second coil element 20 is preferably a single coil pattern p6 and provided in a lowermost layer of the first coil element 10 and the second coil element 20 in the laminating direction. With this structure, the coil patterns p1 and p6 are provided at positions that are not largely separated from the intermediate layers 40a and 40c. That is, the coil patterns p1 positioned at the uppermost layer is close to the intermediate layer 40a and the coil patterns p6 positioned at the lowermost layer is close to the intermediate layer 40c.

The coil patterns p of the first coil element 10 and the second coil element 20 are preferably made of, for example, metal or an alloy including silver as the principal component. The coil patterns p may be plated with, for example, nickel, palladium, or gold.

Although the coil-including component 1 according to the present preferred embodiment includes, for example, interlayer conductors (via conductors) that connect the coil patterns p to one another in the laminating direction and external terminals that electrically connect the coil elements 10 and 20 to an external mounting board and other suitable mounting substrates, illustration of these is omitted from FIG. 2.

The magnetic layers 30 are provided between two coil patterns p4 and p5 included in the first coil portion 11 and between two coil patterns p2 and p3 included in the third coil portion 23. The magnetic layers 30 are also provided in outermost layers of the laminate element body 5.

The magnetic layers 30 are preferably made of, for example, magnetic ferrite ceramics. Specifically, the magnetic layers 30 are preferably made of ferrite that includes iron oxide as the principal component and at least one of zinc, nickel, and copper, for example.

The intermediate layers (layers having a lower magnetic permeability than that of the magnetic layers) 40 are provided between the coil patterns p included in the first coil element 10 and the coil patterns p included in the second coil element 20 adjacent to the corresponding coil patterns p included in the first coil element 10 in the laminating direction. Specifically, the intermediate layers 40 are provided between the first coil portion 11 and the third coil portion 23, between the second coil portion and the third coil portion 23, and between the first coil portion 11 and the fourth coil portion 24.

Furthermore, the intermediate layers 40 are preferably provided, for example, in entire regions parallel or substantially parallel to coil surfaces of the laminate element body 5 between the coil patterns p included in the first coil element 10 and the coil patterns p included in the second coil element 20 adjacent to the corresponding coil patterns p included in the first coil element 10 in the laminating direction.

The intermediate layers 40 are preferably made of, for example, non-magnetic ferrite ceramics or insulative glass ceramics including alumina and glass as the principal components. The intermediate layers 40 may be also referred to as non-magnetic layers.

Next, manufacturing steps of the coil-including component 1 are described.

First, ceramic green sheets for the layers are prepared as mother base materials. Specifically, a slurry including magnetic ceramic powder is formed into sheets so as to prepare ceramic green sheets for the magnetic layers, and a slurry including non-magnetic ceramic powder is formed into sheets so as to prepare ceramic green sheets for the intermediate layers.

Next, a plurality of through holes are formed in specified ceramic green sheets. The through holes are filled with conductor paste so as to form a plurality of via conductors, and a plurality of the coil patterns p are printed with a conductor paste on main surfaces of the green sheets. The through holes are formed by, for example, laser beam machining. The coil patterns p are patterned, for example, by screen printing with a conductor paste that includes, for example, Ag powder.

Next, the ceramic green sheets in which the conductor paste is disposed are laminated and pressure bonded, cut into sections, and then collectively fired. As a result of this firing, the magnetic ceramic powder and the non-magnetic ceramic powder in the green sheets are sintered and the Ag powder in the conductor paste is sintered.

The magnetic ceramics and non-magnetic ceramics are preferably, for example, LTCC ceramics (low temperature co-fired ceramics) the firing temperatures of which are lower than the melting point of silver. This enables silver to be used as the material of the coil patterns p and the via conductors. By configuring the coil elements 10 and 20 using sliver having low resistivity, the coil-including component 1 having low losses is able to be fabricated.

Furthermore, with a sheet laminating fabrication method in which the ceramic green sheets are laminated so as to fabricate the laminate element body 5 as described above, the intermediate layers 40 are able to be easily formed in the entire regions parallel or substantially parallel to the coil surfaces of the laminate element body 5.

In the coil-including component 1 according to the present preferred embodiment, the third coil portion 23 of the second coil element 20 is provided between the first coil portion 11 and the second coil portion 12 of the first coil element 10. Furthermore, the first coil portion 11 of the first coil element 10 is provided between the third coil portion 23 and the fourth coil portion 24 of the second coil element 20. The intermediate layers 40 having low magnetic permeability are provided between the first coil portion 11 and the third coil portion 23, between the second coil portion 12 and the third coil portion 23, and between the first coil portion 11 and the fourth coil portion 24. This reduces or prevents the formation of minor loops at the coil patterns. As a result, the degree of coupling between the first coil element 10 and the second coil element 20 is improved.

Furthermore, when the coil portion 12 or 24 of the first coil element 10 and the second coil element 20 provided in the uppermost layer or the lowermost layer includes a single coil pattern p, the number of coil patterns that are largely separated from the intermediate layers 40 is able to be reduced. Accordingly, even when the coil-including component 1 includes the coil patterns of a small number of layers and has a small height (small size), the degree of coupling between the first coil element 10 and the second coil element 20 is improved.

In the case in which the first coil portion or the third coil portion is the coil patterns of three or more layers, minor loops may be produced at the coil pattern between the upper and lower ends. However, when the first coil portion 11 and the third coil portion 23 each include two coil patterns p as described in the present preferred embodiment, the formation of the minor loops at the first coil portion 11 and the third coil portion 23 is able to be reduced or prevented. Accordingly, even when the coil-including component 1 includes the coil patterns of a small number of layers and has a reduced height (reduced size), the degree of coupling between the first coil element 10 and the second coil element 20 is improved.

Here, variants of the coil-including component 1 according to the first preferred embodiment of the present invention are described.

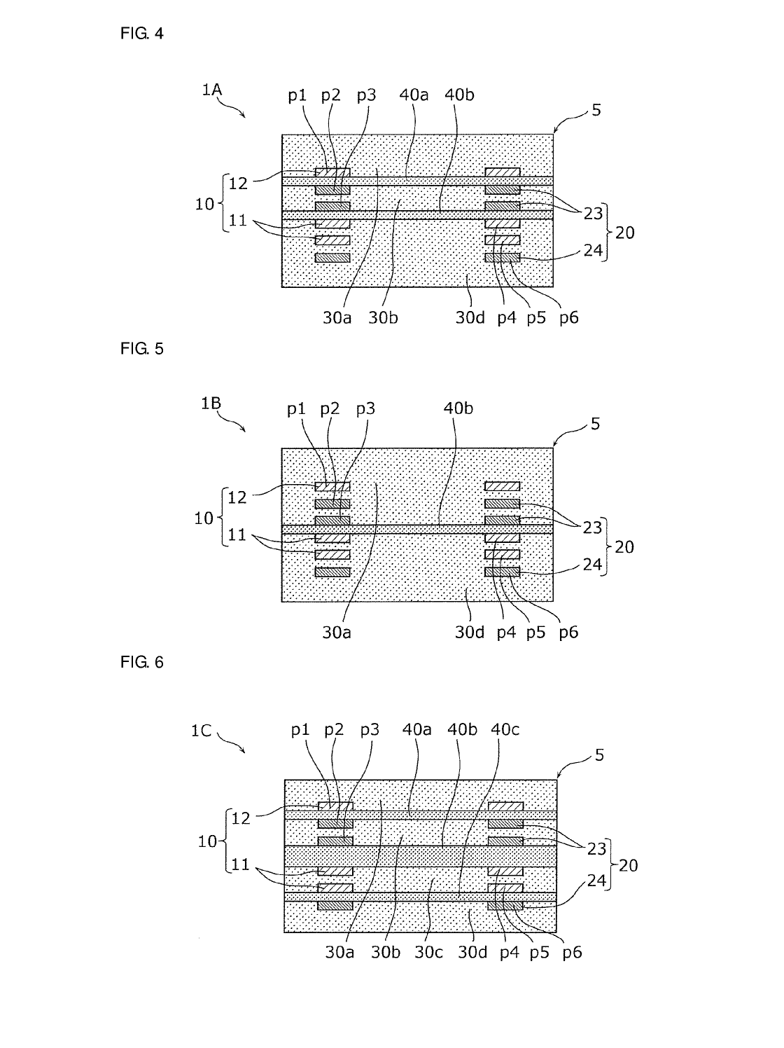

FIG. 4 is a schematic sectional view of a coil-including component 1A according to a first variant of the first preferred embodiment. FIG. 5 is a schematic sectional view of a coil-including component 1B according to a second variant of the first preferred embodiment. In the above-described coil-including component 1, the intermediate layers 40 are preferably provided between all of the coil patterns p included in the first coil element 10 and the corresponding coil patterns p included in the second coil element 20 adjacent to the coil patterns p of the first coil element 10 in the laminating direction. However, the intermediate layers 40 are not necessarily provided between all of the coil patterns p included in the first coil element 10 and the corresponding coil patterns p included in the second coil element 20 adjacent to the coil patterns p of the first coil element 10 in the laminating direction.

For example, as is the case with the coil-including component 1A according to the first variant illustrated in FIG. 4, the intermediate layers 40 (40a and 40b) may preferably be provided between the first coil portion 11 and the third coil portion 23 and between the second coil portion 12 and the third coil portion 23.

With this structure, the number of coil patterns p largely separated from the intermediate layers 40 is able to be reduced as compared to the related art. As a result, magnetic fluxes (minor loops) produced around lines of the coil patterns are able to be reduced or prevented, and accordingly, the degree of coupling between the first coil element 10 and the second coil element 20 is improved.

Furthermore, as is the case with the coil-including component 1B according to the second variant illustrated in FIG. 5, only one of the intermediate layers 40 (40b) may preferably be provided between the first coil portion 11 and the third coil portion 23. Alternatively, although not illustrated, the intermediate layer 40 may preferably only be provided between the second coil portion 12 and the third coil portion 23.

With one of these structures, the generation of magnetic fluxes that do not contribute to an improvement of the degree of coupling are able to be reduced or prevented, and accordingly, the degree of coupling between the first coil element 10 and the second coil element 20 is improved. Furthermore, a desired degree of coupling is able to be obtained by appropriately setting the positions at which the intermediate layers 40 are provided in the laminate element body 5.

FIG. 6 is a schematic sectional view of a coil-including component 1C according to a third variant of the first preferred embodiment. In the coil-including component 1C described in the third variant, at least one of the plurality of intermediate layers 40 preferably has a different thickness from those of the other intermediate layers 40. Specifically, the thickness of the intermediate layer 40b positioned at the center or approximate center in the laminating direction of the laminate element body 5 is increased as compared to those of the other intermediate layers 40a and 40c. Although not illustrated, the thicknesses of the other intermediate layers 40a and 40c may be increased or reduced.

With this structure, the degree of coupling between the coils is able to be controlled, and accordingly, a coil-including component in which the degree of coupling between the first coil element 10 and the second coil element 20 is highly accurately adjusted is provided.

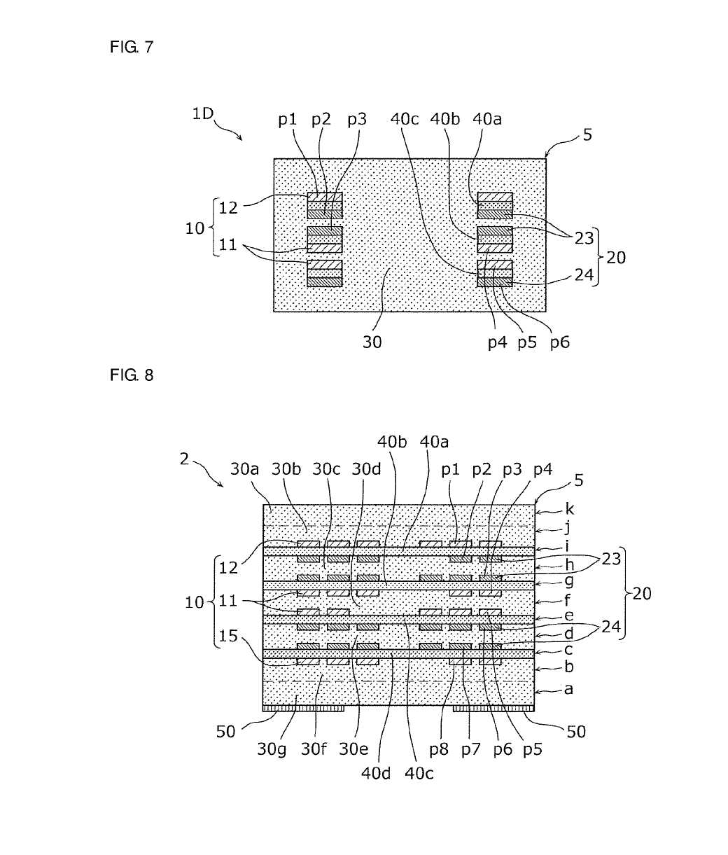

FIG. 7 is a schematic sectional view of a coil-including component 1D according to a fourth variant of the first preferred embodiment.

In the coil-including component 1D, the intermediate layers 40 are partially provided, instead of entirely provided, in the regions parallel or substantially parallel to the coil surfaces of the laminate element body 5. Specifically, the intermediate layers 40 are structured in similar pattern shapes to those of the coil patterns p and provided only in regions in which the coil patterns p included in the first coil element 10 and the corresponding coil patterns p included in the second coil element adjacent to the coil patterns p included in the first coil element 10 in the laminating direction face one another. That is, the insides and the outsides of the coil elements 10 and 20 in the radial direction are made of a magnetic material.

With this structure, the formation of minor loops at the coil patterns is able to be reduced or prevented, and the intermediate layers 40 do not obstruct a major loop that is a magnetic flux along the windings of the coil elements 10 and 20 and that links the coil elements 10 and 20. Thus, the degree of coupling between the first coil element 10 and the second coil element 20 is further improved.

As in the above description including the description of the variants, in each of the coil-including components 1, 1A, 1B, 1C, and 1D, the third coil portion 23 of the second coil element 20 is provided between the first coil portion 11 and the second coil portion 12 of the first coil element 10, and the intermediate layer 40 having low magnetic permeability is provided in at least one of the positions between the first coil portion 11 and the third coil portion 23 and between the second coil portion 12 and the third coil portion 23. This reduces or prevents the formation of minor loops at the coil patterns. As a result, the degree of coupling between the first coil element 10 and the second coil element 20 is improved.

That is, as is the case with the coil-including component described in the related art, with a structure in which a first coil element and a second coil element are separately disposed in the up-down direction, there is a limit to the amount of increase in the degree of coupling between two coil elements. However, when a coil portion of the first coil element 10 and a coil portion of the second coil element 20 are arranged in an alternating sequence and the intermediate layers 40 having low magnetic permeability are included at desired positions as described in the present preferred embodiment, minor loops at the desired positions are able to be reduced or prevented, and accordingly, the coil-including component 1 with which the degree of coupling is high is provided.

Furthermore, since the degree of coupling between the first coil element 10 and the second coil element 20 is able to be improved, the degree of coupling is able to be adjusted in a large range by changing the positions and the numbers of the intermediate layers 40 in the laminate element body 5. That is, a design range of the degree of coupling is increased.

Furthermore, the magnetic layer 30 (30b or 30c) is provided in at least one of the position between the coil patterns p4 and p5 of the first coil portion 11 of the first coil element 10 and the coil patterns p2 and p3 of the third coil portion 23 of the second coil element 20. Thus, the inductance of at least one of the first coil portion 11 and the third coil portion 23 is able to be increased. Accordingly, the inductance of at least one of the first coil element 10 and the second coil element 20 is increased.

### Second Preferred Embodiment

Next, a coil-including component according to a second preferred embodiment of the present invention is described.

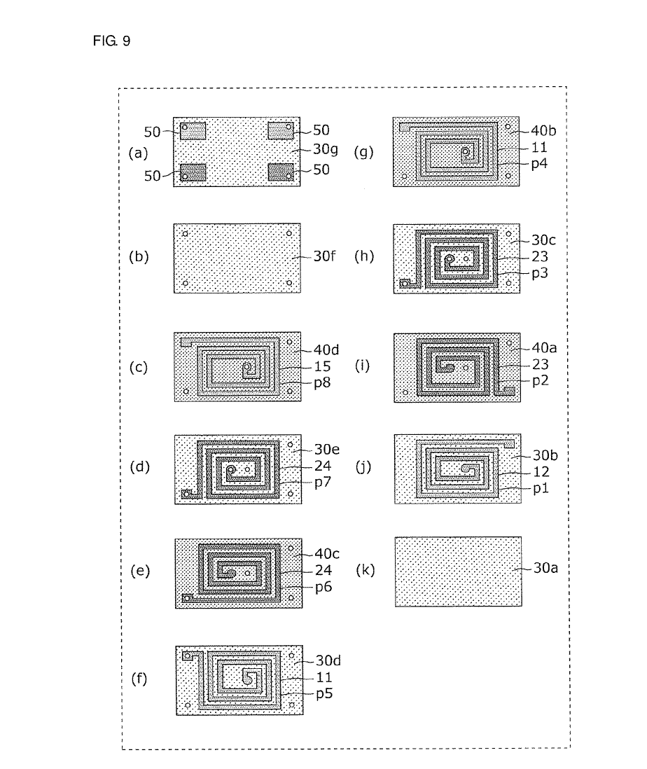

FIG. 8 is a schematic sectional view of a coil-including component 2 according to a second preferred embodiment of the present invention. FIG. 9 illustrates base material layers a to k included in the coil-including component 2 illustrated in FIG. 8 and coil patterns p (p1 to p8) provided in the base material layers a to k.

As illustrated in FIG. 8, the coil-including component 2 includes the laminate element body 5 including a plurality of the base material layers a to k that are laminated. The coil-including component 2 includes the first coil element 10 and the second coil element 20 provided in the laminate element body 5 such that the coil surfaces of the first coil element 10 and the second coil element 20 face one another in the laminating direction.

The plurality of base material layers a to k include magnetic layers 30 (30a to 30g) and intermediate layers 40 (40a to 40d). The magnetic layers 30 are preferably made of a magnetic material. The magnetic permeability of the material of the intermediate layers 40 is preferably lower than that of the material of the magnetic layers 30.

The first coil element 10 and the second coil element 20 are structured such that winding axes (coil axes) of the first coil element 10 and the second coil element 20 are coincident or substantially coincident with each other, and the first coil element 10 and the second coil element 20 are coupled to each other through a magnetic field. The coil patterns p of the coil elements 10 and 20 preferably have spiral shapes. The coil elements 10 and 20 are preferably used as, for example, coils for high frequency.

The first coil element 10 includes a first coil portion 11, a second coil portion 12, and a fifth coil portion 15. The first coil portion 11 includes two coil patterns p4 and p5 adjacent to each other in the laminating direction. The second coil portion 12 includes the coil pattern p1 that faces the coil surfaces of the first coil portion 11. The fifth coil portion 15 includes the coil pattern p8 that faces coil surfaces of the first coil portion 11 and is provided on the opposite side to the second coil portion 12.

The second coil element 20 includes a third coil portion 23 and a fourth coil portion 24. The third coil portion 23 includes two coil patterns p2 and p3 adjacent to each other in the laminating direction. The fourth coil portion 24 includes two coil patterns p6 and p7 that face coil surfaces of the third coil portion 23.

The third coil portion 23 of the second coil element 20 is provided between the first coil portion 11 and the second coil portion 12. Furthermore, the fourth coil portion 24 of the second coil element 20 is provided between the first coil portion 11 and the fifth coil portion 15. The first coil portion 11 of the first coil element 10 is provided between the third coil portion 23 and the fourth coil portion 24.

Furthermore, the second coil portion 12 of the first coil element 10 is preferably a single coil pattern p1 and provided in an uppermost layer in the laminating direction of the first coil element 10. Furthermore, the fifth coil portion 15 of the first coil element 10 is preferably a single coil pattern p8 and provided in a lowermost layer in the laminating direction of the first coil element 10.

The magnetic layers 30 (30c, 30d, and 30e) are respectively provided between two coil patterns p2 and p3 included in the third coil portion 23, between two coil patterns p4 and p5 included in the first coil portion 11, and between two coil patterns p6 and p7 included in the fourth coil portion 24. The magnetic layers 30 are also provided in outermost layers of the laminate element body 5.

The intermediate layers (layers having a lower magnetic permeability than that of the magnetic layers 30) 40 are preferably provided, for example, at four respective positions between the coil patterns p included in the first coil element 10 and the coil patterns p included in the second coil element 20 adjacent to the corresponding coil patterns p included in the first coil element 10 in the laminating direction. Specifically, the intermediate layers 40 are preferably provided, for example, between the first coil portion 11 and the third coil portion 23, between the second coil portion 12 and the third coil portion 23, between the first coil portion 11 and the fourth coil portion 24, and between the fourth coil portion 24 and the fifth coil portion 15.

Furthermore, the intermediate layers 40 are preferably provided in entire regions parallel or substantially parallel to coil surfaces of the laminate element body 5 between the coil patterns p included in the first coil element 10 and the coil patterns p included in the second coil element 20 adjacent to the corresponding coil patterns p included in the first coil element 10 in the laminating direction.

Next, the base material layers a to k included in the coil-including component 2 are described with reference to FIG. 9. Views (a) to (k) of FIG. 9 illustrate the base material layers a to k and the coil patterns p1 to p8 seen from the lower surface side. The base material layers a to k are laminated sequentially from (a) to (k) with lower surfaces of the base material layers a to k facing downward.

The base material layer a illustrated in view (a) of FIG. 9 is the magnetic layer 30g. This magnetic layer 30g is a lower outermost layer of the laminate element body 5. Four rectangular or substantially rectangular external terminals 50 are provided on a bottom surface side of the magnetic layers 30g. A via conductor is connected to each of the four external terminals 50. The via conductors are illustrated as circles in views (a) to (i).

The base material layer b illustrated in view (b) of FIG. 9 is the magnetic layer 30f. Four via conductors are provided in this magnetic layers 30f so as to be connected to the via conductors illustrated in view (a) of FIG. 9.

The base material layer c illustrated in view (c) of FIG. 9 is the intermediate layer 40d. The coil pattern p8 that becomes the fifth coil portion 15 of the first coil element 10 is provided in this intermediate layer 40d.

The base material layer d illustrated in view (d) of FIG. 9 is the magnetic layer 30e. The coil pattern p7 that is the lower coil pattern p of the fourth coil portion 24 of the second coil element 20 is provided in this magnetic layer 30e.

The base material layer e illustrated in view (e) of FIG. 9 is the intermediate layer 40c. The coil pattern p6 that is the upper coil pattern p of the fourth coil portion 24 is provided in this intermediate layer 40c.

The base material layer f illustrated in view (f) of FIG. 9 is the magnetic layer 30d. The coil pattern p5 that is the lower coil pattern p of the first coil portion 11 of the first coil element 10 is provided in this magnetic layer 30d.

The base material layer g illustrated in view (g) of FIG. 9 is the intermediate layer 40b. The coil pattern p4 that is the upper coil pattern p of the first coil portion 11 is provided in this intermediate layers 40b.

The base material layer h illustrated in view (h) of FIG. 9 is the magnetic layer 30c. The coil pattern p3 that is the lower coil pattern p of the third coil portion 23 of the second coil element 20 is provided in this magnetic layer 30c.

The base material layer i illustrated in view (i) of FIG. 9 is the intermediate layer 40a. The coil pattern p2 that is the upper coil pattern p of the third coil portion 23 is provided in this intermediate layers 40a.

The base material layer j illustrated in view (j) of FIG. 9 is the magnetic layer 30b. The coil pattern p1 that becomes the second coil portion 12 of the first coil element 10 is provided in this magnetic layer 30b.

The base material layer k illustrated in view (k) of FIG. 9 is the magnetic layer 30a. This magnetic layer 30a is an upper outermost layer of the laminate element body 5.

These base material layers a to k are sequentially laminated and pressed, and after that, degreased and fired so as to fabricate the coil-including component 2.

Also with the coil-including component 2 described in the second preferred embodiment, the advantageous effects obtained with the coil-including component 1 described in the first preferred embodiment are similarly obtained. That is, the number of coil patterns largely separated from the intermediate layers 40 is able to be reduced, the formation of minor loops at the coil patterns is able to be reduced or prevented, and the degree of coupling between the first coil element 10 and the second coil element 20 is improved. For example, with the coil-including component according to the related art, the coupling coefficient K between both the coil elements is about 0.7 whereas, with the coil-including component according to the present preferred embodiment, the coupling coefficient K between both the coil elements is 0.8 or larger.

Although the coil-including components according to the preferred embodiments of the present invention and the variants of the preferred embodiments have been described, the present invention is not limited to the individual preferred embodiments and the variants of these preferred embodiments. Structures in which a variety of variants conceived by persons skilled in the art are made to the preferred embodiments and the variants of the present preferred embodiments and structures which are configured by combining the elements of the different preferred embodiments and the variants of the different preferred embodiments may be included in the scope of one or a plurality of structured according to the present invention without departing from the gist of the present invention.

For example, in the equivalent circuit illustrated in FIG. 3, four terminals are illustrated as lead terminals. However, two terminals on the output side may be connected to each other so as to define a single terminal in the coil-including component. Furthermore, the laminating direction of the coil-including component may be upside down. Furthermore, each of the coil patterns of the coil-including component may be a single-turn coil pattern, a half-turn coil pattern, or a spiral coil pattern, for example. Furthermore, the intermediate layers may be provided so that the magnetic layers and the intermediate layers arranged in the laminating direction are symmetrical to one another. When the intermediate layers are arranged in the laminating direction so as to be symmetrical to the magnetic layers, deformation of the laminate element body during firing is able to be reduced.

The coil-including components according to preferred embodiments of the present invention are able to be widely used for any of dual inductors, such as a common mode choke coil, a transformer, a coupler, and a balun, for example, and in structures in which the coil-including component is included in a multilayer circuit component, such as a choke coil for a multiphase DC-DC converter, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A coil-including component comprising:
a laminate element body including a plurality of base material layers that are laminated; and
a first coil element and a second coil element provided in the laminate element body such that coil surfaces of the first coil element and a coil surface of the second coil element face in a laminating direction; wherein
the first coil element includes at least: a first coil portion that includes at least two coil patterns adjacent to each other in the laminating direction; and a second coil portion that includes at least one coil pattern;
the second coil element includes at least: a third coil portion that includes at least two coil patterns adjacent to each other in the laminating direction; wherein
the third coil portion is provided between the first coil portion and the second coil portion;
a magnetic layer is provided in at least one of positions between the at least two coil patterns included in the first coil portion and between the at least two coil patterns included in the third coil portion; and
an intermediate layer having a lower magnetic permeability than a magnetic permeability of the magnetic layer is provided in at least one of positions between the first coil portion and the third coil portion and between the second coil portion and the third coil portion.

2. The coil-including component according to claim 1, wherein
the second coil portion is provided on a lowermost layer or an uppermost layer in the laminating direction of the first coil element and the second coil element; and
the at least one coil pattern of the second coil portion includes a single coil pattern.

3. The coil-including component according to claim 1, wherein
the second coil element includes at least: the third coil portion; and a fourth coil portion that includes at least one coil pattern;
the first coil portion is provided between the third coil portion and the fourth coil portion; and
the intermediate layer is provided between the first coil portion and the fourth coil portion.

4. The coil-including component according to claim 3, wherein
the fourth coil portion is provided on a lowermost layer or an uppermost layer in the laminating direction of the laminate element body of the first coil element and the second coil element; and
the at least one coil pattern of the fourth coil portion includes a single coil pattern.

5. The coil-including component according to claim 1, wherein the at least two coil patterns of the first coil portion include two coil patterns and the at least two coil patterns of the third coil portion include two coil patterns.

6. The coil-including component according to claim 1, wherein the intermediate layers are provided between the coil patterns included in the first coil element and the coil patterns included in the second coil element adjacent to the corresponding coil patterns included in the first coil element in the laminating direction.

7. The coil-including component according to claim 1, wherein the intermediate layers are provided in entire regions parallel or substantially parallel to the coil patterns surfaces of the laminate element body between the coil patterns included in the first coil element and the coil patterns included in the second coil element adjacent to the corresponding coil patterns included in the first coil element in the laminating direction.

8. The coil-including component according to claim 1, wherein the intermediate layers are provided only in regions where the coil patterns included in the first coil element and the coil patterns included in the second coil element adjacent to the corresponding coil patterns included in the first coil element in the laminating direction face one another.

9. The coil-including component according to claim 1, wherein
the coil-including component includes a plurality of intermediate layers; and
at least one of the plurality of intermediate layers has a different thickness from a thickness of another or others of the plurality of intermediate layers.

10. The coil-including component according to claim 1, wherein
magnetic layers are provided at all positions between the two coil patterns that are included in the first coil portion and that are adjacent to each other in the laminating direction and between the two coil patterns that are included in the third coil portion and that are adjacent to each other in the laminating direction; and
the intermediate layers having lower magnetic permeability than the magnetic permeability of the magnetic layers are provided at all the positions between the first coil portion and the third coil portion adjacent to each other in the laminating direction and between the second coil portion and the third coil portion adjacent to each other in the laminating direction.
